(19) United States
(12) Patent Application Publication
(10) Pub. No.: US 2019/0132137 A1
(43) Pub. Date: May 2, 2019

(54) LOW NOISE PHYSICALLY UNCLONABLE FUNCTION (PUF) CELL

(71) Applicant: QUALCOMM Incorporated, San Diego, CA (US)

(72) Inventors: Guoan Zhong, San Diego, CA (US); Nan Chen, San Diego, CA (US); Junmou Zhang, San Diego, CA (US)

(21) Appl. No.: 15/802,354

(22) Filed: Nov. 2, 2017

(51) Int. Cl. H04L 9/32

(52) U.S. Cl. CPC H04L 9/3278; H04L 2209/12

(57) ABSTRACT

Aspects of the disclosure are directed to a low noise physically unclonable function (PUF) cell. In accordance with one aspect, the low noise physically unclonable function (PUF) cell includes a first inverter, wherein the first inverter is configured in a negative feedback configuration; and a second inverter coupled to the first inverter in a series configuration, wherein the second inverter is configured in a first open loop configuration.

### TECHNICAL FIELD

This disclosure relates generally to the field of cryptography, and, in particular, to a physically unclonable function (PUF) cell.

### BACKGROUND

In security applications, information may be one asset that needs to be secured. One technique commonly used to secure information is cryptography to hide information using cryptographic keys. In one example, cryptography may employ a plurality of cryptographic primitives to secure information or devices. Physically unclonable functions (PUF) may be circuit elements that are used as cryptographic primitives.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a low noise physically unclonable function (PUF) cell. Accordingly, a low noise physically unclonable function (PUF) cell including a first inverter, wherein the first inverter is configured in a negative feedback configuration; and a second inverter coupled to the first inverter in a series configuration, wherein the second inverter is configured in a first open loop configuration. In one example, the first inverter includes a first negative channel metal oxide semiconductor (NMOS) transistor and a first positive channel metal oxide semiconductor (PMOS) transistor, wherein the first NMOS transistor is connected in series to the first PMOS transistor. In one example, the PUF cell further includes a first NMOS transistor gate terminal and a first PMOS transistor gate terminal, wherein the first NMOS transistor gate terminal is connected to the first PMOS transistor gate terminal.

In one example, the first inverter includes a first inverter input and a first inverter output. In one example, the second inverter includes a second inverter input and a second inverter output. In one example, the negative feedback configuration is implemented with the first inverter output connected to the first inverter input and connected to the second inverter input. In one example, the first open loop configuration is implemented with the second inverter output not connected to the second inverter input.

In one example, the first inverter includes a first negative channel metal oxide semiconductor (NMOS) transistor and a first positive channel metal oxide semiconductor (PMOS) transistor, wherein the first NMOS transistor is connected in series to the first PMOS transistor. And further, a first NMOS transistor gate terminal and a first PMOS transistor gate terminal are included, wherein the first NMOS transistor gate terminal is connected to the first PMOS transistor gate terminal.

In one example, the PUF cell includes a third inverter, wherein the third inverter is connected in series to the second inverter. In one example, the third inverter is configured in a second open loop configuration. In one example, the third inverter includes a third inverter input and a third inverter output. In one example, the second open loop configuration is implemented with the third inverter output not connected to the third inverter input.

In one aspect, the disclosure provides a method for implementing a low noise physically unclonable function (PUF) cell, the method including configuring a first inverter in a negative feedback configuration; and coupling a second inverter in series to the first inverter, wherein the second inverter is configured in a first open loop configuration. In one example, the first inverter includes a first inverter input and a first inverter output, and the second inverter includes a second inverter input and a second inverter output. In one example, the method further includes connecting the second inverter input to the first inverter output, and further includes inputting a first bias voltage to the second inverter input, wherein the first bias voltage is outputted through the first inverter output. In one example, the method further includes connecting the first PMOS transistor in series to the first NMOS transistor.

In one example, the first inverter includes a first negative channel metal oxide semiconductor (NMOS) transistor and a first positive channel metal oxide semiconductor (PMOS) transistor. In one example, the first NMOS transistor includes a first NMOS transistor gate terminal and the first PMOS transistor includes a first PMOS transistor gate terminal. In one example, the method further includes connecting the first NMOS transistor gate terminal to the first PMOS transistor gate terminal.

In one example, the second inverter includes a second negative channel metal oxide semiconductor (NMOS) transistor and a second positive channel metal oxide semiconductor (PMOS) transistor. In one example, the second NMOS transistor includes a second NMOS transistor gate terminal and the second PMOS transistor includes a second PMOS transistor gate terminal; and further including connecting the second NMOS transistor gate terminal to the second PMOS transistor gate terminal. In one example, the method further includes determining a middle point of voltage symmetry and biasing the low noise PUF cell at the middle point of voltage symmetry. And, in one example, the method further includes coupling a third inverter in series to the second inverter, wherein the third inverter is configured in a second open loop configuration.

In one aspect, the disclosure provides an apparatus for implementing a low noise physically unclonable function (PUF) cell, the apparatus including means for configuring a first inverter in a negative feedback configuration; and means for coupling a second inverter in series to the first inverter, wherein the second inverter is configured in a first open loop configuration. In one example, the apparatus further includes means for determining a middle point of voltage symmetry and means for biasing the low noise PUF cell at the middle point of voltage symmetry.

In one example, the first inverter includes a first negative channel metal oxide semiconductor (NMOS) transistor with a first NMOS transistor gate terminal, and the first inverter further includes a first positive channel metal oxide semiconductor (PMOS) transistor with a first PMOS transistor gate terminal; and further including means for connecting the first NMOS transistor gate terminal to the first PMOS transistor gate terminal. In one example, the second inverter includes a second negative channel metal oxide semiconductor (NMOS) transistor with a second NMOS transistor gate terminal, and the second inverter further includes a second positive channel metal oxide semiconductor (PMOS) transistor with a second PMOS transistor gate terminal; and further including means for connecting the second NMOS transistor gate terminal to the second PMOS transistor gate terminal.

In one aspect, the disclosure provides a computer-readable medium storing computer executable code, operable on a device including at least one processor and at least one memory coupled to the at least one processor, wherein the at least one processor is configured to implement a low noise physically unclonable function (PUF) cell, the computer executable code including instructions for causing a computer to configure a first inverter in a negative feedback configuration; and instructions for causing a computer to couple a second inverter in series to the first inverter, wherein the second inverter is configured in a first open loop configuration.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates an example of a static random access memory (SRAM)-based physically unclonable function (PUF) cell.

FIG. 2 illustrates an example of a ring oscillator physically unclonable function (PUF) cell.

FIG. 3 illustrates an example block diagram of a static random access memory (SRAM)-based physically unclonable function (PUF) cell.

FIG. 4 illustrates an example block diagram of a low noise physically unclonable function (PUF) cell.

FIG. 5 illustrates an example block diagram of a low noise physically unclonable function (PUF) cell with a PUF cell output which depends on a plurality of trigger voltages.

FIG. 6 illustrates an example of a low noise physically unclonable function (PUF) cell with three stages.

FIG. 7 illustrates an example of three histogram graphs with each of the three histogram graphs corresponding to one of the three stages of the low noise PUF cell described in FIG. 6.

FIG. 8 illustrates an example of a static random access memory (SRAM)-based physically unclonable function (PUF) cell with identical cross-coupled inverters with positive feedback.

FIG. 9 illustrates an example of a notional graph of output states, the notational graph corresponds with the PUF cell of FIG. 8.

FIG. 10 illustrates an example of a low noise physically unclonable function (PUF) cell with identical inverters configured with a negative feedback in a first stage and an open loop buffer in a second stage.

FIG. 11 illustrates an example input-output voltage transfer function graph which corresponds to the low noise PUF cell of FIG. 10.

FIG. 12 illustrates an example flow diagram 1200 for implementing a low noise physically unclonable function (PUF) cell.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Physically unclonable functions (PUF) are circuit elements which may be used as cryptographic primitives. A PUF may provide information security at a circuit level. For example, a PUF may be employed to generate unique, stable and secure cryptographic keys for device authentication and information security. One example of a PUF is a silicon PUF. A silicon PUF exploits semiconductor process variations to generate unique silicon “fingerprints” to serve as a cryptographic primitive. In one example, a silicon fingerprint is a unique, repeatable physical characteristic of a silicon device which may be used as discriminator of a particular integrated circuit.

Random information may be extracted from a PUF for a private key or as a chip fingerprint. Examples of PUFs may include a static random access memory (SRAM)-based PUF which relies on local variations of cross-coupled inverters to sense a voltage mismatch upon power up. In some examples, a SRAM-based PUF may have a high noise level (due to a closed loop feedback configuration) and may require error correction coding (ECC). In one example, a closed loop feedback configuration is a positive feedback configuration. And, in some examples, area overhead (e.g., additional footprint) may be needed to correct induced bit errors.

Another example is a ring oscillator PUF. In some examples, the ring oscillator PUF may rely on measuring a frequency difference between ring oscillators. The ring oscillator PUF may be sensitive to voltage and temperature. And, in some examples, area overhead (e.g., additional footprint) may be needed to include other components to mitigate the sensitivity to voltage and temperature.

In some examples, random physical characteristics due to random dopant fluctuations or dimension mismatch on a semiconductor chip may not be reproducible over a population of chips but may be easy to measure. A silicon fingerprint may be extracted from a PUF for a private key or as a chip identifier. For example, semiconductor process variations during chip manufacture may not be reproducible by the semiconductor manufacturer.

In an example, a silicon PUF may be used as an unclonable key for a cryptographic lock which secures information. For example, the cryptographic lock may have a database of challenge-response pairs to determine whether or not to grant access to secured information. The cryptographic lock may be opened if the unclonable key may need to reply to a challenge with a response which is matched to the challenge.

In one aspect, the present disclosure relates to a digital inverter chain PUF with a novel low noise design. In one example, the topology of the digital inverter chain PUF may be an open-loop cascade of identically designed inverters where the first inverter has interconnected input and output ports in a negative feedback configuration to produce a first bias voltage. The first bias voltage is fed as an input to a second inverter. The digital inverter chain PUF is an open loop circuit with improved noise immunity versus a closed loop circuit as in a SRAM-based PUF for example. In addition, the digital inverter chain PUF may be biased at a middle point of voltage symmetry with very high gain to amplify small mismatches between the inverters into a stable digital signal. In one example, the disclosed configuration yields a stable, yet random unique digital signature that is useful as a cryptographic primitive. In one example, the minimum number of inverters needed is two with the first inverter configured in a negative feedback configuration and the second inverter connected in series with the first inverter. The two inverters may have identical (or similar) layouts, but may have intrinsic random semiconductor process variations to yield unique digital signatures with strong noise immunity. As a result, minimal error correction coding (ECC) and small area overhead are needed. In one example, being identical inverters means that the inverter layouts are similar within a tolerance specification, and/or may have intrinsic random semiconductor process variations to yield unique digital signatures with strong noise immunity.

In one example, a dopant is an element added to a semiconductor to control device properties. Semiconductor chips may have random dopant fluctuations (RDF) which may result in differences in silicon fingerprints. And, in one example, a silicon fingerprint represented as a two-dimensional binary pattern may be extracted from a semiconductor device for a chip fingerprint or for a private key.

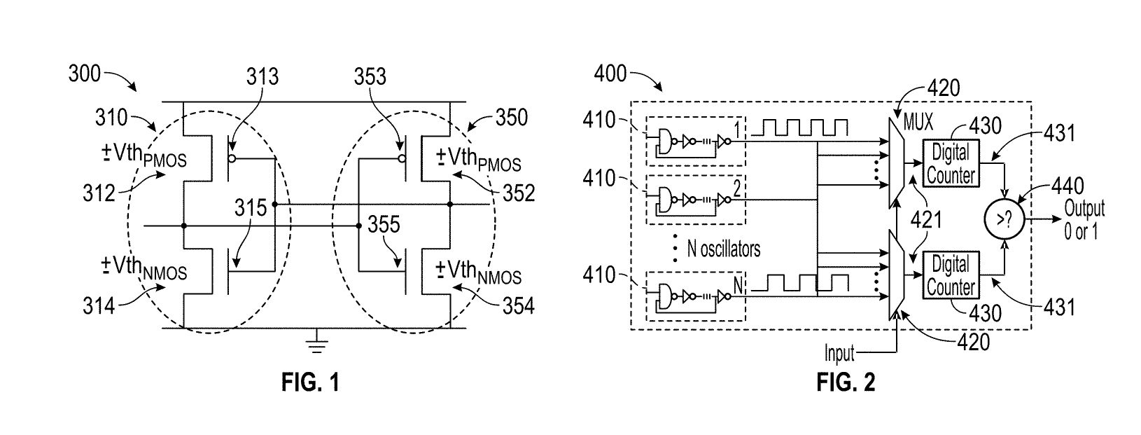

FIG. 1 illustrates an example of a static random access memory (SRAM)-based physically unclonable function (PUF) cell 300. The SRAM-based PUF cell 300 is shown in FIG. 1 with a pair of cross-coupled inverters 310, 350. For example, each inverter (310, 350) includes a positive channel metal oxide semiconductor (PMOS) transistor 312, 352 and a negative channel metal oxide semiconductor (NMOS) transistor 314, 354 with connected gate terminals (e.g., gate terminals 313 and 315 are connected, and gate terminals 353 and 355 are connected). In one example, the SRAM-based PUF cell may rely on device local mismatch of cross-coupled inverters to sense a threshold voltage (e.g., Vth_{PMOS}, Vth_{NMOS}) mismatch during power ON. For example, the threshold voltage sensing may be sensitive to voltage and temperature variations and may be subject to random bit errors. In one example, a bit error rate may be around 10%. In one example, the random bit errors may require error correction coding (ECC) overhead for mitigation, which may require additional chip area (e.g., additional footprint) due to the extra circuitry needed for the mitigation. In one example, a SRAM-based PUF cell may be part of a semiconductor foundry design intellectual property (IP) which may not be not under the designer's control.

FIG. 2 illustrates an example of a ring oscillator physically unclonable function (PUF) cell 400. The ring oscillator PUF cell example shown in FIG. 2 includes a quantity N of ring oscillators 410 driving a plurality of multiplexers (MUX) 420. In one example, the outputs 421 of the multiplexer (MUX) 420 are sent to digital counters 430 to measure ring oscillator frequency or period. Next, the digital counter outputs 431 may be compared to determine which digital counter has a higher value. In one example, the comparison component 440 outputs a 0 or a 1 depending on which digital counter has the higher value. In one example, the ring oscillator PUF cell 400 measures a difference of ring oscillator frequency or period. For example, the ring PUF cell 400 may be sensitive to voltage and temperature, and thus, may require additional chip area (e.g., additional footprint) to include extra circuitry needed to mitigate the sensitivity to voltage or temperature. In addition, the ring PUF cell 400 may accommodate a limited quantity of challenge-response pairs and there may not be a simple burn in mechanism to stability the ring PUF circuitry.

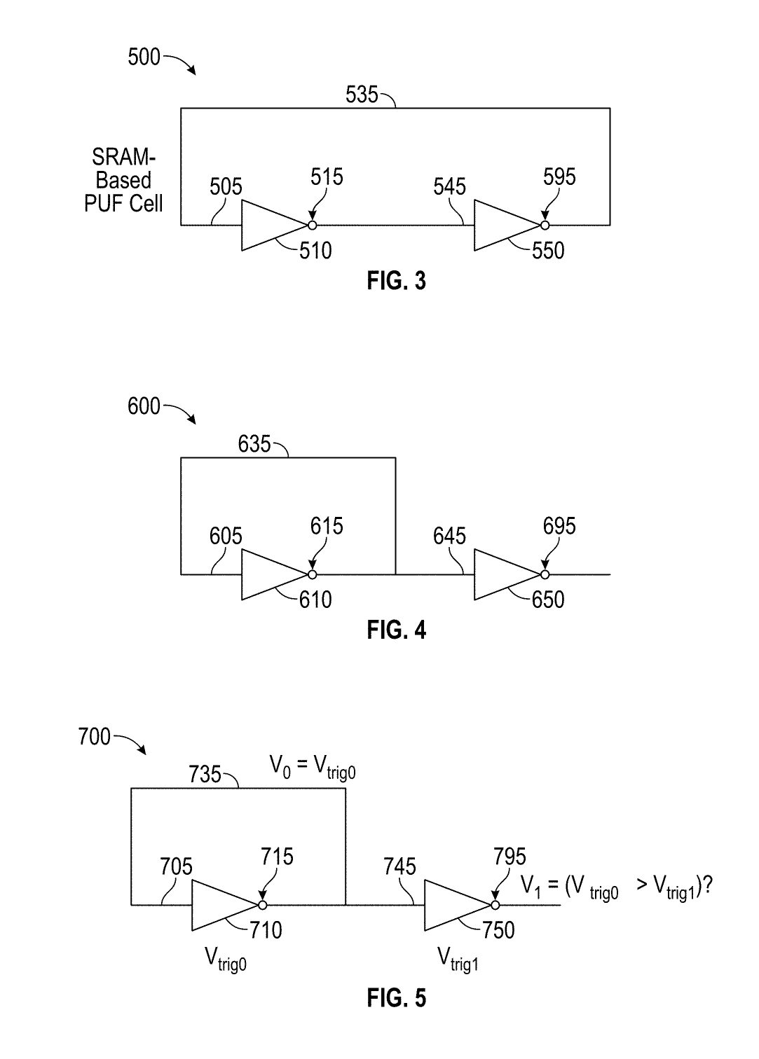

FIG. 3 illustrates an example block diagram of a static random access memory (SRAM)-based physically unclonable function (PUF) cell 500. As shown in FIG. 3, the example SRAM-based PUF cell 500 includes a first inverter 510 and a second inverter 550 in a closed loop configuration (indicated as 535). In one example, a closed loop feedback configuration is a positive feedback configuration. For example, first inverter output 515 is connected to the second inverter input 545, and the second inverter output 595 is connected to the first inverter input 505. In one example, the SRAM-based PUF cell 500 is a cross-coupled inverter.

FIG. 4 illustrates an example block diagram of a low noise physically unclonable function (PUF) cell 600. In the example shown in FIG. 4, the low noise PUF cell 600 includes a first inverter 610 and a second inverter 650 coupled in series. One skilled in the art would understand that the first inverter 610 and the second inverter 650 coupled in series may include the two converters connected directly to each other in series (as shown in FIG. 4).

The first inverter 610 may be configured in a negative feedback configuration (indicated as 635) where the first inverter output 615 is connected to the first inverter input 605 and connected to the second inverter input 645. Also shown in FIG. 4 is the second inverter output 695. In one example, the low noise PUF cell 600 is less sensitive to random noise and demonstrates more stable circuit behavior.

FIG. 5 illustrates an example block diagram of a low noise physically unclonable function (PUF) cell 700 with a PUF cell output which depends on a plurality of trigger voltages. As shown in FIG. 5, the PUF cell 700 includes two inverters 710, 750 coupled to each other in series. One skilled in the art would understand that the first inverter 710 and the second inverter 750 coupled in series may include the two converters connected directly to each other in series (as shown in FIG. 5), or in other examples, additional intervening components (not shown in FIG. 5) may be included in the series connection between the first inverter 710 and the second inverter 750 within the scope and spirit of the present disclosure. As shown in FIG. 5, the first inverter 710 may be configured in a negative feedback configuration (indicated as 735) where the first inverter output 715 is connected to the first inverter input 705 and connected to the second inverter input 745. As shown in FIG. 5, the voltage on the negative feedback configuration 735 is labeled as V₀.

For example, the first inverter 710 includes a first trigger voltage Vt_{rig0} and a second inverter 750 includes a second trigger voltage V_{trig1}. As indicated in FIG. 5, in one example, the first inverter output 715 V₀ is equal to the first trigger voltage Vt_{rig0}. For example, a trigger voltage is a voltage level which is a transition between two output states, e.g., LOW and HIGH. In one example, the first inverter 710 is a high gain inverter and the second inverter 750 operates as an amplifier. For example, the second inverter output 795 (labeled as V₁) may be set to a LOW state (“0”) if the first trigger voltage V_{trig0} is greater than the second trigger voltage V_{trig1}. For example, the second inverter output 795 (labeled as V₁) may be set to a HIGH state (“1”) if the first trigger voltage V_{trig0} is less than the second trigger voltage V_{trig1}. That is, dependent on the specific characteristics of the two inverters (i.e., first inverter 710 and second inverter 750), the relative comparison between the first trigger voltage V_{trig0} and the second trigger voltage V_{trig1} may differ which results in a different value at the second inverter output 795. In one example, the first inverter 710 and the second inverter 750 have identical designs but have different physical properties due to manufacturing variations between the two inverters. Also, as shown in the example of FIG. 5, the PUF cell output is the same as the second inverter output 795.

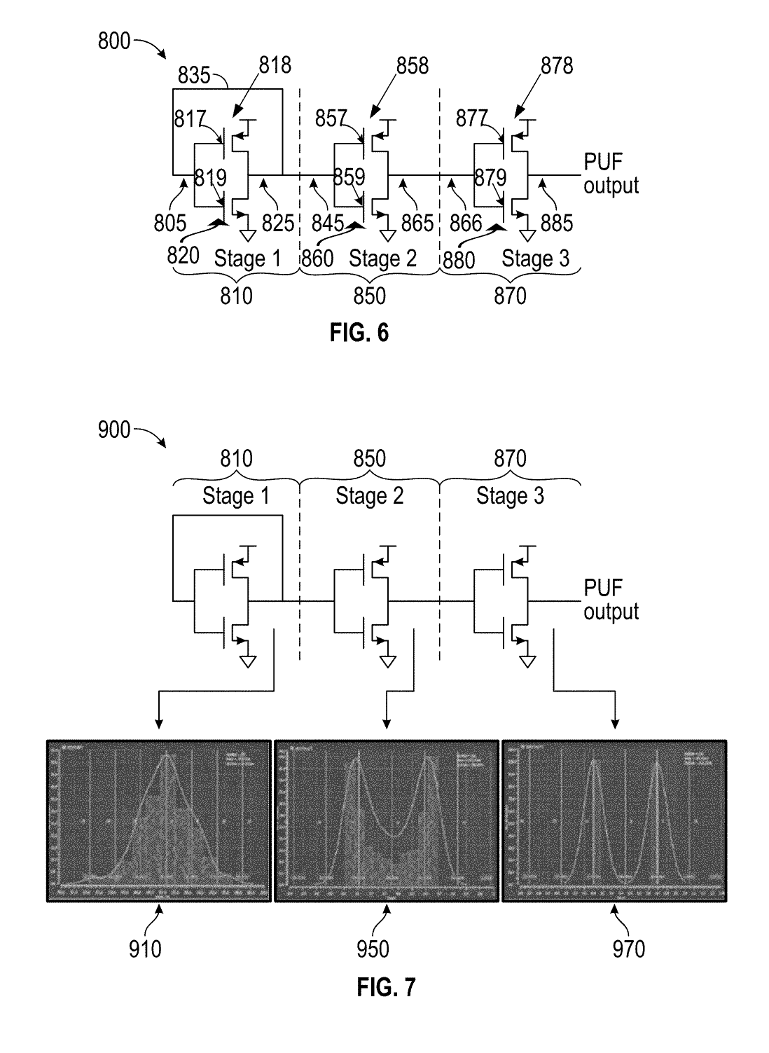

FIG. 6 illustrates an example of a low noise physically unclonable function (PUF) cell 800 with three stages. In one example, each stage of the three stages 810, 850, 870 is an inverter. A first stage 810 includes a first NMOS transistor 820 connected in series to a first PMOS transistor 818.

In one example, a gate terminal 819 of the first NMOS transistor 820 (a.k.a., a first NMOS transistor gate terminal 819) and a gate terminal 817 of the first PMOS transistor 818 (a.k.a., a first PMOS transistor gate terminal 818) are connected (i.e., tied together). For example, the first stage 810 is connected in a negative feedback configuration (indicated as 835) where a first stage output 825 is connected to a first stage input 805. For example, the negative feedback configuration (indicated as 835) results in the first stage output 825 toggling between a LOW state and a HIGH state.

A second stage 850 includes a second NMOS transistor 860 connected in series to a second PMOS transistor 858. In one example, a gate terminal 859 of the second NMOS transistor 860 and a gate terminal 857 of the second PMOS transistor 858 are tied together. For example, the second stage 850 is coupled in an open loop configuration where a second stage output 865 is not connected to a second stage input 845.

A third stage 870 includes a third NMOS transistor 880 connected in series to a third PMOS transistor 878. In one example, a gate terminal 879 of the third NMOS transistor 880 and a gate terminal 877 of the third PMOS transistor 878 are tied together. For example, the third stage 870 is connected in an open loop configuration where a third stage output 885 is not connected to a third stage input 866.

In one example, the low noise PUF cell 800 includes the three stages 810, 850, 870 connected in cascade. That is, the first stage output 825 is connected to the second stage input 845 and the second stage output 865 is connected to the third stage input 866. In another example, the low noise PUF cell may include two stages connected in cascade, with only the first stage 810 and the second stage 850. In this case, for example, the first stage output 825 is connected to the second stage input 845. And, in the two stage example, the first stage is configured in a negative feedback configuration where the first inverter output is connected to the first inverter input and connected to the second inverter input. And, the second stage is configured in an open loop configuration where the second stage output is not connected to the second stage input.

In yet another example, the low noise PUF cell may include more than three stages, with the first stage configured in a negative feedback configuration where the first inverter output is connected to the first inverter input and connected to the second inverter input. In the more than three stage example, the stages other than the first stage are in open loop configurations where the output of each stage is not connected to the input of that stage. In one example, the inverter of the first stage 810, the inverter of the second stage 850 and the inverter of the third stage 870 are identical inverters. In one example, being identical inverters means that the inverter layouts are identical in design, and may have intrinsic random semiconductor process variations to yield unique digital signatures with strong noise immunity.

FIG. 7 illustrates an example 900 of three histogram graphs 910, 950, 970 with each of the three histogram graphs corresponding to one of the three stages 810, 850, 870 of the low noise PUF cell 800 described in FIG. 6. Each histogram graph shows a simulated Monte Carlo probability distribution of output voltage values for each stage of the low noise PUF cell 800. For example, a first histogram graph 910 (shown on the left side of FIG. 7) shows an output voltage probability distribution for the first stage 810 as an approximately symmetric function of output voltage. For example, a second histogram graph 950 (shown on the middle of FIG. 7) shows output voltage probability distribution for the second stage 850 as a slightly pronounced bimodal function of output voltage. For example, a third histogram graph 970 (shown on the right side of FIG. 7) shows an output voltage probability distribution for the third stage 850 as a highly pronounced bimodal function of output voltage.

In one example, the output voltage probability distribution which has a more pronounced bimodal function of output voltage may be used as a basis for a PUF signature. In one example, “pronounced” means the degree of separation in the probability distribution between its peak value and its centroid. For example, the output voltage probability distribution for the third stage 870 may be well-balanced in probability between two distinct voltage values. For example, well-balanced in probability may mean that that a median voltage value is symmetrically positioned between the centroid of the two bimodal peaks of the probability distribution. That is, a 50^{th} percentile value of the probability distribution may be symmetrically positioned relative to the centroids which facilitates a good discrimination over process, voltage and temperature (PVT) between a LOW and HIGH state for the low noise PUF cell output. In one example, the degree of separation in the probability distribution of a final stage between its peak value and its centroid may be increased by adding more stages to the low noise PUF cell.

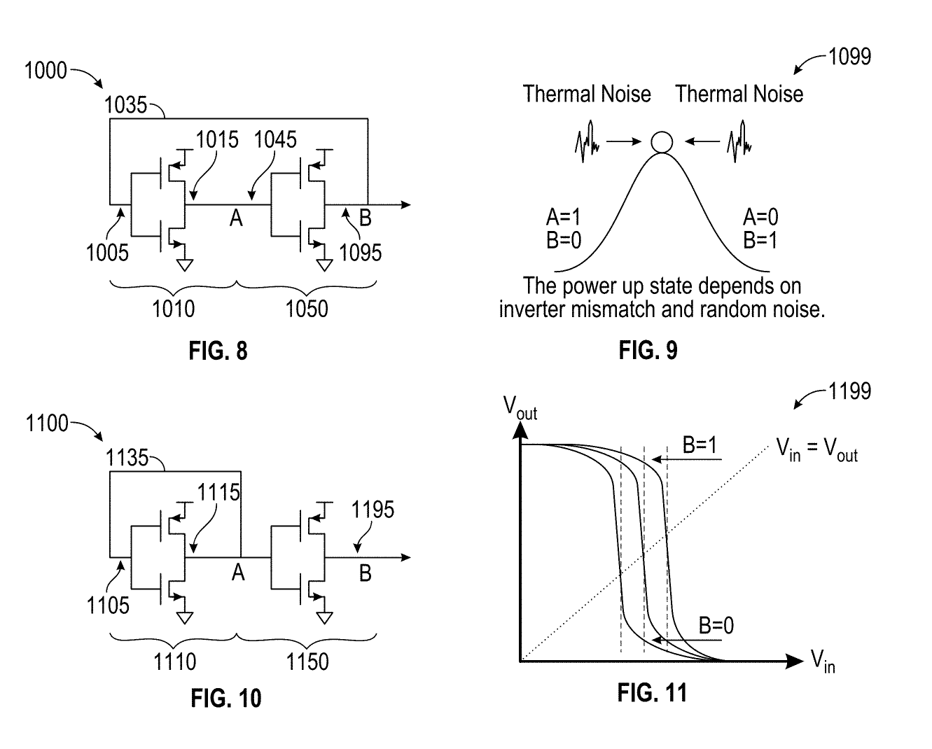

FIG. 8 illustrates an example of a static random access memory (SRAM)-based physically unclonable function (PUF) cell 1000 with identical cross-coupled inverters with positive feedback. Shown in FIG. 8 is a first inverter 1010 with a first inverter output 1015 and a second inverter 1050 with a second inverter output 1095 which is fed back to a first inverter input 1005 of the first inverter 1010 in a positive feedback configuration (labeled as 1035). As shown in FIG. 8, the labels “A” and “B” indicate the outputs of the first and the second inverters, respectively.

FIG. 9 illustrates an example of a notional graph 1099 of output states, the notational graph 1099 corresponds with the PUF cell 1000 of FIG. 8. In one example, the notional graph 1099 of output states illustrates a low level that corresponds to a stable state and a high level that corresponds to an unstable state. For example, a power up state may be in a first state with the first inverter output 1015 in a HIGH state and second inverter output 1095 in a LOW state. In another example, the power up state may be in a second state with first inverter output 1015 in a LOW state and second inverter output 1095 in a HIGH state. For example, power up state may depend on circuit mismatches between the first inverter 1010 and the second inverter 1050 or may depend on random noise which cause voltage fluctuations. Also shown is the first inverter output 1015 connected to the second inverter input 1045.

FIG. 10 illustrates an example of a low noise physically unclonable function (PUF) cell 1100 with identical inverters configured with a negative feedback in a first stage (which corresponds to a first inverter 1110) and an open loop buffer in a second stage (which corresponds to a second inverter 1150). The first inverter 1110 includes a first inverter output 1115 in a negative feedback configuration (labeled as 1135) connected to a first inverter input 1105. The second inverter 1150 includes a second inverter output 1195 in an open loop buffer configuration. As shown in FIG. 10, the labels “A” and “B” indicate the outputs of the first and the second inverters, respectively.

FIG. 11 illustrates an example input-output voltage transfer function graph 1199 which corresponds to the low noise PUF cell 1100 of FIG. 10. FIG. 11 is an input-output voltage transfer function graph 1199 which corresponds to the low noise PUF cell 1100 where the output voltage depends only on a threshold voltage mismatch between the first inverter 1110 and the second inverter 1150.

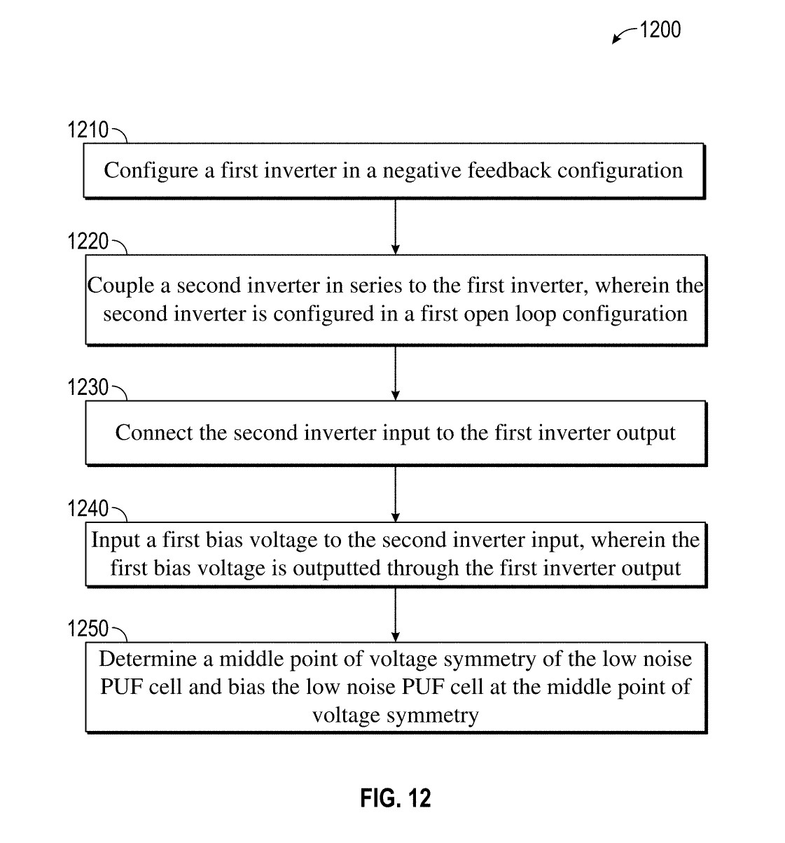

FIG. 12 illustrates an example flow diagram 1200 for implementing a low noise physically unclonable function (PUF) cell. In block 1210, configure a first inverter in a negative feedback configuration. In one example, the first inverter includes a first inverter input and a first inverter output. In one example, the first inverter includes a first negative channel metal oxide semiconductor (NMOS) transistor and a first positive channel metal oxide semiconductor (PMOS) transistor. In one example, the first PMOS transistor is connected in series to the first NMOS transistor to form the first inverter.

In block 1220, couple a second inverter in series to the first inverter, wherein the second inverter is configured in a first open loop configuration. In one example, the second inverter includes a second inverter input and a second inverter output. In one example, the second inverter includes a second negative channel metal oxide semiconductor (NMOS) transistor and a second positive channel metal oxide semiconductor (PMOS) transistor. In one example, the second PMOS transistor is connected in series to the second NMOS transistor to form the second inverter.

In block 1230, connect the second inverter input to the first inverter output. In block 1240, input a first bias voltage to the second inverter input, wherein the first bias voltage is outputted through the first inverter output. In block 1250, determine a middle point of voltage symmetry of the low noise PUF cell and bias the low noise PUF cell at the middle point of voltage symmetry. In one example, one or more processors may be coupled to one or more peripheral test equipment to determine the middle point. Some examples of peripheral test equipment are digital voltmeter, oscilloscope, network analyzer, spectrum analyzer, etc. In one example, the coupling of the one or more processor to the one or more peripheral equipment is achieved by using an Ethernet or local area network (LAN) connection. In one example, once the middle point of voltage symmetry of the low noise PUF cell is determined, its value may be stored in a memory. The memory may be coupled with the one or more processor for biasing the low noise PUF cell.

In one aspect, one or more of the steps for providing a low noise physically unclonable function (PUF) cell in FIG. 12 may be executed by one or more processors which may include hardware, software, firmware, etc. In one aspect, one or more of the steps in FIG. 12 may be executed by one or more processors which may include hardware, software, firmware, etc. The one or more processors, for example, may be used to execute software or firmware needed to perform the steps in the flow diagram of FIG. 14. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in the processing system, external to the processing system, or distributed across multiple entities including the processing system. The computer-readable medium may be embodied in a computer program product. By way of example, a computer program product may include a computer-readable medium in packaging materials. The computer-readable medium may include software or firmware for implementing a low noise physically unclonable function (PUF) cell. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A low noise physically unclonable function (PUF) cell comprising:
a first inverter, wherein the first inverter is configured in a negative feedback configuration; and
a second inverter coupled to the first inverter in a series configuration, wherein the second inverter is configured in a first open loop configuration.

2. The PUF cell of claim 1, wherein the first inverter comprises a first negative channel metal oxide semiconductor (NMOS) transistor and a first positive channel metal oxide semiconductor (PMOS) transistor, wherein the first NMOS transistor is connected in series to the first PMOS transistor.

3. The PUF cell of claim 2, further comprising a first NMOS transistor gate terminal and a first PMOS transistor gate terminal, wherein the first NMOS transistor gate terminal is connected to the first PMOS transistor gate terminal.

4. The PUF cell of claim 1, wherein the first inverter comprises a first inverter input and a first inverter output.

5. The PUF cell of claim 4, wherein the second inverter comprises a second inverter input and a second inverter output.

6. The PUF cell of claim 5, wherein the negative feedback configuration is implemented with the first inverter output connected to the first inverter input and connected to the second inverter input.

7. The PUF cell of claim 6, wherein the first open loop configuration is implemented with the second inverter output not connected to the second inverter input.

8. The PUF cell of claim 7, wherein the first inverter comprises a first negative channel metal oxide semiconductor (NMOS) transistor and a first positive channel metal oxide semiconductor (PMOS) transistor, wherein the first NMOS transistor is connected in series to the first PMOS transistor.

9. The PUF cell of claim 8, further comprising a first NMOS transistor gate terminal and a first PMOS transistor gate terminal, wherein the first NMOS transistor gate terminal is connected to the first PMOS transistor gate terminal.

10. The PUF cell of claim 9, further comprising a third inverter, wherein the third inverter is connected in series to the second inverter.

11. The PUF cell of claim 10, wherein the third inverter is configured in a second open loop configuration.

12. The PUF cell of claim 11, wherein the third inverter comprises a third inverter input and a third inverter output.

13. The PUF cell of claim 12, wherein the second open loop configuration is implemented with the third inverter output not connected to the third inverter input.

14. A method for implementing a low noise physically unclonable function (PUF) cell, the method comprising:
configuring a first inverter in a negative feedback configuration; and
coupling a second inverter in series to the first inverter, wherein the second inverter is configured in a first open loop configuration.

15. The method of claim 14, wherein the first inverter includes a first inverter input and a first inverter output.

16. The method of claim 15, wherein the second inverter includes a second inverter input and a second inverter output.

17. The method of claim 16, further comprising connecting the second inverter input to the first inverter output.

18. The method of claim 17, further comprising inputting a first bias voltage to the second inverter input, wherein the first bias voltage is outputted through the first inverter output.

19. The method of claim 14, wherein the first inverter includes a first negative channel metal oxide semiconductor (NMOS) transistor and a first positive channel metal oxide semiconductor (PMOS) transistor.

20. The method of claim 19, further comprising connecting the first PMOS transistor in series to the first NMOS transistor.

21. The method of claim 19, wherein the first NMOS transistor includes a first NMOS transistor gate terminal and the first PMOS transistor includes a first PMOS transistor gate terminal; and further comprising connecting the first NMOS transistor gate terminal to the first PMOS transistor gate terminal.

22. The method of claim 21, wherein the second inverter includes a second negative channel metal oxide semiconductor (NMOS) transistor and a second positive channel metal oxide semiconductor (PMOS) transistor.

23. The method of claim 22, wherein the second NMOS transistor includes a second NMOS transistor gate terminal and the second PMOS transistor includes a second PMOS transistor gate terminal; and further comprising connecting the second NMOS transistor gate terminal to the second PMOS transistor gate terminal.

24. The method of claim 14, further comprising:
determining a middle point of voltage symmetry and
biasing the low noise PUF cell at the middle point of voltage symmetry.

25. The method of claim 14, further comprising coupling a third inverter in series to the second inverter, wherein the third inverter is configured in a second open loop configuration.

26. An apparatus for implementing a low noise physically unclonable function (PUF) cell, the apparatus comprising:
means for configuring a first inverter in a negative feedback configuration; and
means for coupling a second inverter in series to the first inverter, wherein the second inverter is configured in a first open loop configuration.

27. The apparatus of claim 26, wherein the first inverter includes a first negative channel metal oxide semiconductor (NMOS) transistor with a first NMOS transistor gate terminal, and the first inverter further includes a first positive channel metal oxide semiconductor (PMOS) transistor with a first PMOS transistor gate terminal; and further comprising means for connecting the first NMOS transistor gate terminal to the first PMOS transistor gate terminal.

28. The apparatus of claim 27, wherein the second inverter includes a second negative channel metal oxide semiconductor (NMOS) transistor with a second NMOS transistor gate terminal, and the second inverter further includes a second positive channel metal oxide semiconductor (PMOS) transistor with a second PMOS transistor gate terminal; and further comprising means for connecting the second NMOS transistor gate terminal to the second PMOS transistor gate terminal.

29. The apparatus of claim 28, further comprising:
means for determining a middle point of voltage symmetry and
means for biasing the low noise PUF cell at the middle point of voltage symmetry.

30. A computer-readable medium storing computer executable code, operable on a device comprising at least one processor and at least one memory coupled to the at least one processor, wherein the at least one processor is configured to implement a low noise physically unclonable function (PUF) cell, the computer executable code comprising:
instructions for causing a computer to configure a first inverter in a negative feedback configuration; and
instructions for causing a computer to couple a second inverter in series to the first inverter, wherein the second inverter is configured in a first open loop configuration.
